(19) United States
(12) Patent Application Publication
(10) Pub. No.: US 2004/0259746 A1
(43) Pub. Date: Dec. 23, 2004

(54) Concentrate composition and process for removing coatings from surfaces such as paint application equipment

(76) Inventors: Jonathan N. Warren, Dearborn, MI (US); Phillip J. Beauchamp, Roseville, MI (US)

Correspondence Address: PPG INDUSTRIES, INC., Intellectual Property Department, One PPG Place, Pittsburgh, PA, 15272, US

(21) Appl. No.: 10/600,915

(22) Filed: Jun. 20, 2003

(51) Int. Cl. C11D 1/00

(52) U.S. Cl. 510/201

(57) ABSTRACT

A concentrate composition for removing coatings from surfaces such as paint application equipment is provided, which comprises:

(a) 0 to 99.5 percent by weight of acetone, methyl acetate and/or water;

(b) 0.01 to 35 percent by weight of at least one surfactant selected from pyrrolidone-derived surfactants having substituents containing 6 to 14 carbon atoms and alkoxylated acetylenic compounds; and

(c) 0.5 to 90 percent by weight of at least one pH adjusting component selected from ammonia and amines having alkanyl groups, hydroxyalkanyl groups, or aminoalkanyl groups having 1 to 8 carbon atoms.

The volatile organic compound (VOC) content of the composition is less than 2.0 lb./gal. Also provided is a process for removing coatings from surfaces comprising diluting the concentrate composition described above with water to form a cleaning solution; and contacting the surfaces with the cleaning solution until coating residues are substantially removed from the surfaces.

### FIELD OF THE INVENTION

The present invention relates to concentrate compositions and processes for removing coating residues from surfaces, in particular, from paint application equipment such as manual and automated paint spray and dipping equipment.

### BACKGROUND OF THE INVENTION

Over the past twenty years, there has been a concerted effort among manufacturers to reduce atmospheric pollution caused by volatile solvents that are released during industrial painting processes. One of the major goals of the coatings industry is to minimize the use of organic solvents by formulating water reducible coating compositions that provide excellent appearance as well as good physical properties. In the automotive industry and in other industrial painting processes, water reducible coating compositions are typically applied to substrates using electrostatic paint sprayers in specially designed paint spray booths. This paint application equipment needs to be cleaned periodically during routine maintenance and color change operations, and when paint formulations are changed. Like the coatings themselves, cleaning compositions used to remove the coatings from the paint spray equipment are more often water reducible compositions, in order to be compatible with the coatings they are being used to remove from the equipment. However, many of these cleaning compositions, despite being water reducible, contain significant levels of organic amines, aromatic compounds, and organic solvents that are known as volatile organic compounds (VOC's).

PCT application WO 02/053802 A1 discloses the use of alkoxylated aromatic alcohols in combination with alkanolamines in water to remove paint residues from spraying equipment.

PCT application WO 02/085994 A1 discloses the use of C₄ alcohols and their derivatives in combination with amines to remove paint residues from spraying equipment.

U.S. Pat. No. 5,591,702 discloses an alkaline paint stripper composition comprising a mixture of (i) glycol and/or oligoglycol monoethers with (ii) unetherified glycols and oligoglycols and/or alkanolamines.

U.S. Pat. No. 6,074,999 discloses a cleaning agent for cleaning paint piping, based on N-methyl-2-pyrrolidone and containing an amine-type solvent and a nonionic surfactant.

U.S. Pat. No. 6,517,626 B2 discloses a universal paint solvent comprising an acidic material and an organic solvent.

It would be desirable to provide a water reducible concentrate composition for removing coatings from paint application equipment and other surfaces from which uncured paint needs to be removed. In particular, a water reducible composition having a minimal VOC content that is suitable for removing coating residues from surfaces would be highly desirable.

### SUMMARY OF THE INVENTION

The present invention provides a concentrate composition for removing coatings from paint application equipment and other surfaces from which wet or dried uncured paint needs to be removed. The composition comprises:

(a) 0 to 99.5 percent by weight of a carrier selected from at least one of acetone, methyl acetate and water;

(b) 0.01 to 35 percent by weight of at least one surfactant selected from one or more of pyrrolidone-derived surfactants having substituents containing 6 to 14 carbon atoms and alkoxylated acetylenic compounds; and

(c) 0.5 to 90 percent by weight of at least one pH adjusting component having the structure:

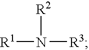

wherein R¹, R², and R³ are independently selected from the group consisting of hydrogen, alkanyl groups having 1 to 8 carbon atoms, hydroxyalkanyl groups having 1 to 8 carbon atoms, and aminoalkanyl groups having 1 to 8 carbon atoms. When the concentrate composition contains at least 20% by weight water, the concentrate composition may further comprise up to 5.0 percent by weight of at least one hydrotropic surfactant different from the other components in the composition. Note that all percentages by weight are based on the total weight of the concentrate composition.

The volatile organic compound (VOC) content of the composition is less than 2.0 lb./gal.

Also provided is a process for removing coatings from surfaces comprising diluting the concentrate composition described above with water to form a cleaning solution, and contacting surfaces with the cleaning solution until coating residues are substantially removed from the surfaces.

### DETAILED DESCRIPTION OF THE PREFERRED EMBODIMENTS

Other than in the operating examples, or where otherwise indicated, all numbers expressing quantities of ingredients, reaction conditions and so forth used in the specification and claims are to be understood as being modified in all instances by the term “about.” Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

The concentrate composition of the present invention is useful for removing coatings from paint application equipment, and any other surfaces from which wet or dried uncured paint needs to be removed. The concentrate composition comprises:

(a) 0 to 99.5 percent by weight of a carrier selected from at least one of acetone, methyl acetate and water;

(b) 0.01 to 35 percent by weight of at least one surfactant selected from one or more of pyrrolidone-derived surfactants having substituents containing 6 to 14 carbon atoms and alkoxylated acetylenic compounds; and

(c) 0.5 to 90 percent by weight of at least one pH adjusting component having the structure:

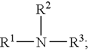

wherein R¹, R², and R³ are independently selected from the group consisting of hydrogen, alkanyl groups having 1 to 8 carbon atoms, hydroxyalkanyl groups having 1 to 8 carbon atoms, and aminoalkanyl groups having 1 to 8 carbon atoms. The volatile organic compound (VOC) content of the composition is less than 2.0 lb./gal.

As used herein, by “alkanyl” is meant an alphatic hydrocarbon derived from an alkane, but having one unsatisfied valence. By “hydroxyalkanyl is meant an alkanyl group having one H substituted with an OH group.

Acetone and methyl acetate, used alone or in admixture, have been found to be useful cosolvents in the composition of the present invention, keeping the other components stable in solution, particularly upon dilution with water to a working concentration for cleaning applications. When used in admixture, the weight ratio of acetone to methyl acetate typically ranges from 20:80 to 80:20. The water used in the concentrate composition of the present invention is typically deionized water. Distilled water is also suitable, and when necessary, tap water or water from another source may be used. The carrier of component (a) is present in a total amount ranging from 0 to 99.5 percent by weight based on the total weight of the concentrate composition, often 50 to 99 percent by weight, more often 85 to 95 percent by weight.

The surfactant(s) used as component (b) in the concentrate composition of the present invention include one or more of pyrrolidone-derived surfactants having substituents containing 6 to 14 carbon atoms and/or alkoxylated (ethoxylated and/or propoxylated) acetylenic compounds. Specific examples include n-octyl pyrrolidone and n-dodecyl pyrrolidone, such as Surfadone LP-100 and Surfadone LP-300, commercially available from ISP, and alkoxylated acetylenic diols such as Surfynol 440 and Surfynol 2502, commercially available from Air Products and Chemicals Co. The surfactant(s) is present in the concentrate composition in an amount ranging from 0.01 to 35 percent by weight based on the total weight of the concentrate composition, often 0.01 to 5.0 percent by weight, more often 0.3 to 3.0 percent by weight.

The concentrate composition of the present invention further comprises a pH adjustment component (c) having the structure:

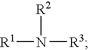

wherein R¹, R², and R³ are independently selected from the group consisting of hydrogen, alkanyl groups having 1 to 8 carbon atoms, hydroxyalkanyl groups having 1 to 8 carbon atoms, and aminoalkanyl groups having 1 to 8 carbon atoms. The pH adjustment component may be selected from one or more of ammonia and organic amines including, but not limited to, dimethylethanolamine, diethanolamine, triethanolamine, isopropanolamine, and aminomethylpropanol. In an embodiment of the present invention dimethylethanolamine is used. The pH adjustment component can be present in the concentrate composition in an amount ranging from 0.5 to 90 percent by weight based on the total weight of the concentrate composition, often 0.5 to 20 percent by weight, more often 1 to 15 percent by weight. The weight ratio of component (b) to component (c) can range from 1:2 to 1:10.

In a particular embodiment of the invention, when the concentrate composition contains at least 20% by weight water, the concentrate composition may further comprise up to 5.0 percent by weight of at least one hydrotropic surfactant different from the other components in the composition in addition to or in place of the acetone and/or methyl acetate. The hydrotropic surfactant may be selected from one or more of aromatic or aliphatic sulfonates, for example, disodium hexadecyldiphenyloxide disulfonate in conjunction with disodium dihexadecyidiphenyloxide disulfonate, such as Dowfax Hydrotrope Surfactant, commercially available from Dow Chemical Co., or benzene, 1,1′, -oxybis-, sec-hexyl derivatives, sulfonated sodium salts, such as Dowfax Detergent Surfactant, commercially available from Dow Chemical Co. When used, the hydrotropic surfactant can be present in the concentrate composition in an amount ranging from 0.01 to 5.0 percent by weight based on the total weight of the concentrate composition, often 0.1 to 3.0 percent by weight, more often 0.2 to 2.0 percent by weight.

If desired, the concentrate composition can comprise other optional materials (additives) such as auxiliary surfactants including defoamers, organic cosolvents, and other customary auxiliaries. These materials, either individually or in combination, can constitute up to 10 percent by weight of the total weight of the concentrate composition, depending on the nature of the 1 0 additive.

In a particular embodiment of the invention, the concentrate composition comprises:

(a) 50 to 99 percent by weight, based on the total weight of the concentrate composition, acetone or a mixture of methyl acetate and acetone;

(b) 0.01 to 5 percent by weight, based on the total weight of the concentrate composition, of at least one pyrrolidone-derived surfactant; and

(c) 0.5 to 20 percent by weight, based on the total weight of the concentrate composition, dimethylethanolamine.

In a separate embodiment of the present invention, the concentrate composition comprises:

(a) at least 20 percent by weight, typically 50 to 99 percent by weight, based on the total weight of the concentrate composition, water;

(b) 0.01 to 5 percent by weight, based on the total weight of the concentrate composition, of at least one pyrrolidone-derived surfactant;

(c) 0.5 to 20 percent by weight, based on the total weight of the concentrate composition, dimethylethanolamine; and

(d) 0.01 to 5.0 percent by weight, based on the total weight of the concentrate composition, of at least one hydrotropic surfactant different from the other components in the composition.

In another specific embodiment of the present invention, the concentrate composition comprises:

(a) at least 20 percent by weight, based on the total weight of the concentrate composition, water;

(b) 0.01 to 5 percent by weight, based on the total weight of the concentrate composition, of at least one surfactant selected from alkoxylated acetylenic compounds;

(c) 0.5 to 20 percent by weight, based on the total weight of the concentrate composition, dimethylethanolamine; and

(d) up to 5.0 percent by weight, based on the total weight of the concentrate composition, of at least one hydrotropic surfactant different from the other components in the composition.

The concentrate composition of the present invention may be used to prepare a cleaning solution for removing coatings from surfaces. Such a cleaning solution comprises any of the concentrate compositions described above, diluted with water to a concentration of up to 30 percent by weight, based on the total weight of the cleaning solution.

The concentrate composition of the present invention may further be used to remove coatings from surfaces such as paint application equipment and other substrates from which uncured paints need to be removed. Such a process, in accordance with the present invention, comprises:

(a) diluting the concentrate composition described above with water to form a cleaning solution; and

(b) contacting the surfaces with the cleaning solution until coating residues are substantially removed from the surfaces.

The concentrate composition may be diluted With deionized water in step (a) to prepare the cleaning solution. Distilled water is also suitable, and when necessary, tap water or water from any other source may be used. Upon dilution, the concentrate composition can be present in the cleaning solution in an amount ranging from 1 to 30 percent by weight based on the total weight of the cleaning solution, often 2.5 to 20 percent by weight, more often 5 to 15 percent by weight.

After preparation of the cleaning solution, the surfaces are contacted with the cleaning solution until coating residues are substantially removed from the surfaces. Contact time varies as indicated below, depending on the thickness, age and composition of the coating to be removed, and on the method of contact.

The process of the present invention may be used to clean various substrates to which coatings have been applied, including wood, metals, glass, polymeric substrates and the like. The process is especially useful for cleaning metals and other substrates that are found in paint application equipment. Automated and manual paint application equipment such as paint sprayers and dip installations are particularly well suited for the process of the present invention.

During step (b), the cleaning solution may be contacted with the surfaces of the paint application equipment or other substrates to be cleaned using any of a variety of methods including brushing, dipping (immersion), flow coating, spraying, and the like. Immersion may include agitation of the cleaning solution to improve the cleaning efficiency of the solution. When surfaces are contacted with the cleaning solution via immersion, contact times typically range from about 0.1 to about 24 hours, depending on the thickness, age and composition of the coating to be removed. Contact times may be increased or decreased as necessary until the coating has been substantially removed from the substrate. The cleaning solution is most often sprayed onto the surfaces or circulated through paint application equipment. Spraying is employed when feasible because the abrasive mechanical force associated with impingement of the sprayed cleaning solution improves the cleaning efficiency of the solution. When spraying is employed, contact times typically range from about 1 to about 60 seconds, depending on the thickness, age and composition of the coating to be removed. Again, contact times may be increased or decreased as necessary.

In a particular embodiment of the invention, after step (a), the cleaning solution may be heated prior to contacting the surfaces to be cleaned, to improve the coating removal efficiency. Heating should not be to a temperature so high as to unnecessarily increase energy costs. When heating is employed, typically the cleaning solution is heated to a temperature of 33 to 54° C.

The process of the present invention may include a final rinsing step with water or a mixture of water and additives to ensure complete removal of coating residues, or alternatively purging high pressure air or nitrogen gas through a paint supply system.

The present invention will further be described by reference to the following examples. The examples are merely illustrative of the invention and are not intended to be limiting. Unless otherwise indicated, all parts are by weight.

Examples 1 to 5 demonstrate a laboratory test to screen waterborne cleaning compositions according to the present invention.

### Test Method

A coating (paint) was applied to a cleaned 7″×7″ (17.8×17.8 cm) glass panel with a 1.5 mil (38.1 micron) draw down bar. The panel was then dehydrated for about 30 minutes (time can be altered to accommodate differences in coating technology) at 120° F. (48.9° C.). After dehydration, the panel was allowed to cool for 5 minutes. A cleaning solution was loaded in a conventional spray gun that had been modified to deliver only fluid from its tip without atomizing air. The fluid pressure was adjusted to 10 psi (68.9 kPa).

The panel was situated orthogonal to and six inches (15.24 cm) from the spray gun tip. A fluid stream of the cleaning solution was applied to the painted panel until an area of approximately 1.25×1.25 centimeters was cleaned. The time to clean the defined area was measured using a stopwatch. Spraying was stopped if one of two conditions occurred:

1. Greater than 30 seconds elapsed

2. The coating was mechanically removed (wrinkling, lifting, etc.) rather than chemically removed through coating dissolution.

If either of these occurred, the time was recorded and followed by an “(F)” to show a failure.

Tested panels were placed in a panel rack to dry completely. The final dry films were evaluated for ancillary effects as described below.

| Rating | Description |
|---|---|
| Aggressive | Large area of paint is affected around the initial target area |
| Moderate | Some areas below the target area are affected |
| None | Only affected area is the target area |

A panel that rates as “None” would have no dissolution of the paint film other than the target area directly where the cleaning solution was applied. A panel that rates as “Moderate” would have areas directly below the target area where the paint had been either dissolved or thinned. A panel that rates as “Aggressive” would have an area around the target area where the paint film had been drastically altered. It is possible that the cleaning solution will have had such an effect on the surrounding film that it dissolves, runs down the panel, and covers the initially cleaned target area.

### EXAMPLE 1

The following concentrate compositions were evaluated using the above method:

| Ingredient | 1-1 | 1-2 | 1-3 |
|---|---|---|---|
| Acetone | 95.0 | 93.5 | 93.5 |
| DMEA | 5.0 | 5.0 | 5.0 |
| Surfadone LP100¹ | 0.0 | 1.5 | 0.0 |
| Surfynol 440² | 0.0 | 0.0 | 1.5 |

¹n-Octyl Pyrrolidone-derived surfactant available from ISP
²Alkoxylated acetylenic diol available from Air Products and Chemicals Co.

All concentrates were diluted to 10% by weight in deionized water. The following table shows the results of the testing:

TABLE I

| Example # | Average Time (sec) | Ancillary Effects |
|---|---|---|
| 1-1 | 1.2 | Moderate |
| 1-2 | 1.6 | Aggressive |
| 1-3 | 1.6 | Aggressive |

The coating tested was HWB8624 Olympic White waterborne automotive base coat available from PPG Industries, Inc.

### EXAMPLE 2

The following concentrate compositions were evaluated using the above method:

| Ingredient | 2-1 | 2-2 |
|---|---|---|
| Water | 94.5 | 93.0 |
| DMEA | 5.0 | 5.0 |
| Surfadone LP100 | 0.0 | 1.5 |
| Dowfax Hydrotrope¹ | 0.5 | 0.5 |

¹Aromatic Sulfonate surfactant available from Dow Chemical Co.

All concentrates were diluted to 10% by weight in deionized water. The following table shows the results of the testing:

TABLE II

| ExamDle # | Average Time (sec) | Ancillary Effects |
|---|---|---|
| 2-1 | 1.5 | Moderate |
| 2-2 | 1.9 | Aggressive |

The coating tested was HWB8624 Olympic White waterborne automotive base coat available from PPG Industries, Inc.

### EXAMPLE 3

The following concentrate compositions were evaluated using the above method:

| Ingredient | 3-1 | 3-2 |
|---|---|---|
| Water | 94.5 | 93.0 |
| DMEA | 5.0 | 5.0 |
| Surfynol 440 | 0.0 | 1.5 |
| Dowfax Detergent¹ | 0.5 | 0.5 |

¹Aromatic Sulfonate surfactant available from Dow Chemical Co.

All concentrates were diluted to 10% by weight in deionized water. The following table shows the results of the testing:

TABLE III

| Example # | Average Time (sec) | Ancillary Effects |
|---|---|---|
| 3-1 | 3.9 | Moderate |
| 3-2 | 2.1 | Aggressive |

The coating tested was HWB8624 Olympic White waterborne automotive base coat available from PPG Industries, Inc.

### EXAMPLE 4

The following concentrate compositions were evaluated using the above method:

| Ingredient | 4-1 | 4-2 | 4-3 |
|---|---|---|---|
| Acetone | 90.0 | 78.0 | 78.0 |
| DMEA | 10.0 | 10.0 | 10.0 |
| Water | 0.0 | 10.0 | 10.0 |
| Surfadone LP100 | 0.0 | 1.5 | 0.0 |
| Surfynol 440 | 0.0 | 0.0 | 2.0 |
| Chemax CO 200/50¹ | 0.0 | 0.5 | 0.0 |

¹Ethoxylated Castor Oil available from Chemax Performance Products.

All concentrates were diluted to 10% by weight in deionized water. The following table shows the results of the testing:

TABLE IV

| Example # | Average Time (sec) | Ancillary Effects |
|---|---|---|
| 4-1 | 1.7 | Moderate |
| 4-2 | 2.2 | Aggressive |
| 4-3 | 2.6 | Aggressive |

The coating tested was HWB8624 Olympic White waterborne automotive base coat available from PPG Industries, Inc.

### EXAMPLE 5

The following concentrate compositions were evaluated using the above method:

| Ingredient | 5-1 | 5-2 | 5-3 |
|---|---|---|---|
| Methyl Acetate | 95.0 | 93.5 | 93.5 |
| DMEA | 5.0 | 5.0 | 5.0 |
| Surfadone LP100 | 0.0 | 1.5 | 0.0 |
| Surfynol 440 | 0.0 | 0.0 | 1.5 |

All concentrates were diluted to 10% by weight in deionized water. The following table shows the results of the testing:

TABLE V

| Example # | Average Time (sec) | Ancillary Effects |
|---|---|---|
| 5-1 | 2.0 | Moderate |
| 5-2 | 2.5 | Aggressive |
| 5-3 | 2.2 | Aggressive |

The coating tested was HWB8624 Olympic White waterborne automotive base coat available from PPG Industries, Inc.

All testing showed that the addition of the surfactant to the compositions improved the ancillary effects of the cleaning compositions. It is believed that the ancillary effects correlate significantly to the overall performance in the field as demonstrated in Example 6 below.

In Example 6, cleaning compositions of the present invention were tested using production equipment typically found in industrial coating operations to determine real-world performance. Testing was conducted at 72° F. (22.2° C.) and 65% Relative Humidity, conditions similar to actual production environments for automotive applications.

### Test Method

A robot equipped with HDC Spray guns (two guns mounted side by side) and fitted with Sames 436-939 Caps was programmed to spray paint for one second at a paint flow rate of 100 ml/min. Paint was sprayed into a standard 5-gallon bucket to produce paint over-spray on the spray caps. The distance of the spray guns to the bucket bottom was set at 28 inches (71.1 cm) to ensure that a very light paint mist developed on the caps. A light over-spray on the cap surface is more difficult to clean than a heavy degree of over-spray.

The robot then moved into a horizontal orientation for a flash period of 120 seconds to allow the over-sprayed paint to dehydrate on the cap surface. After the flash period, the robot moved the guns into a cleaning device (CC2002 Double Gun Cap Cleaner from Crystal Cap Cleaners, Inc (Burlington, Ontario, Canada) equipped with 4/65 and 4/25 nozzles) for cleaning of the caps. 330 ml of a test solution (cleaning composition) was passed through the cleaning equipment for 2 seconds immediately followed by an air stream applied for 6 seconds to the cap surface for drying purposes.

The robot lifted out of the cleaning equipment at 12 inches/second (30.5 cm/sec) to a required distance and returned to a horizontal position for inspection of the caps. After a post-cycle flash time of 60 seconds, the cycle was repeated fifteen times for each cleaning composition.

After all cycles were complete, the caps were carefully removed and allowed to completely dry before being photographed for evaluation.

It is important to note that the temperature and the humidity of the spray booth can greatly influence the test results. It is therefore important to ensure that all testing is conducted under consistent conditions.

Cap Evaluations:

The caps were evaluated using the following scale:

| Rating | Description |
|---|---|
| 10 | Cap is completely clean with no observable |
| | residue |
| 8 | Cap is very clean with very light residue only in |
| | some recessed areas |
| 6 | Cap is clean with residue in recessed areas and |
| | slightly on flat surfaces |
| 4 | Cap is in poor condition with paint residue |
| | covering at least 50% of the surfaces |
| 2 | Cap is very dirty with more than 75% of the |
| | cap being covered with residue |

(It should be noted that the cleanliness of the horns of the cap were excluded from the evaluation.)

### EXAMPLE 6

Formulas 4-1, 4-2, and 4-3 from Example 4 were evaluated using the Test Method outlined above.

| Example # | Concentrate Composition | wt % in DI Water | Cap Evaluation |
|---|---|---|---|
| 6-1 | 4-1 | 10 | 5 |
| 6-2 | 4-2 | 10 | 10 |
| 6-3 | 4-2 | 6 | 9 |
| 6-4 | 4-3 | 10 | 9 |

The coating tested was HWB8624 Olympic White Waterborne Basecoat available from PPG Industries, Inc.

The results showed that the addition of the surfactants greatly increased the cleanliness of the caps. These results also indicate that the ancillary effects of the Laboratory test demonstrated in Examples 1-5 may relate more to product success than time to dissolve the target area.

Those skilled in the art will recognize that changes may be made to the embodiments described above without departing from the broad inventive concept thereof. It is understood, therefore, that this invention is not limited to the particular embodiments disclosed, but it is intended to cover modifications that are within the spirit and scope of the invention, as defined by the appended claims.

We claim:

1. A concentrate composition for removing coatings from surfaces comprising:
(a) 0 to 99.5 percent by weight, based on the total weight of the concentrate composition, of a carrier selected from at least one of acetone, methyl acetate and water;
(b) 0.01 to 35 percent by weight, based on the total weight of the concentrate composition, of at least one surfactant selected from one or more of pyrrolidone-derived surfactants having substituents containing 6 to 14 carbon atoms and alkoxylated acetylenic compounds; and
(c) 0.5 to 90 percent by weight, based on the total weight of the concentrate composition, of at least one pH adjusting component having the structure: 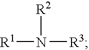
wherein R¹, R², and R³ are independently selected from the group consisting of hydrogen, alkanyl groups having 1 to 8 carbon atoms, hydroxyalkanyl groups having 1 to 8 carbon atoms, and aminoalkanyl groups having 1 to 8 carbon atoms; wherein the volatile organic compound (VOC) content of the composition is less than 2.0 lb./gal; and wherein when the concentrate composition contains at least 20% by weight water, the concentrate composition may further comprise up to 5.0 percent by weight, based on the total weight of the concentrate composition, of at least one hydrotropic surfactant different from the other components in the composition.

2. The composition of claim 1, wherein component (a) includes at least 20% by weight water based on the total weight of the concentrate composition and further comprises a hydrotropic surfactant selected from the group consisting of aromatic and aliphatic sulfonates.

3. A cleaning solution for removing coatings from surfaces comprising the concentrate composition of claim 1 diluted with water to a concentration of up to 30 percent by weight, based on the total weight of the cleaning solution.

4. The composition of claim 1, wherein the weight ratio of component (b) to component (c) ranges from 1:2 to 1:10.

5. The composition of claim 1, wherein (c) is selected from one or more of ammonia, dimethylethanolamine, diethanolamine, triethanolamine, isopropanolamine, and aminomethylpropanol.

6. The composition of claim 1, wherein component (a) is present in an amount ranging from 50 to 99 percent by weight, based on the total weight of the concentrate composition.

7. The composition of claim 6, wherein component (a) is acetone.

8. The composition of claim 1, wherein component (b) is present in an amount ranging from 0.01 to 5 percent by weight, based on the total weight of the concentrate composition.

9. The composition of claim 1, wherein component (c) is present in an amount ranging from 0.5 to 20 percent by weight, based on the total weight of the concentrate composition.

10. A concentrate composition for removing coatings from surfaces comprising:
(a) 50 to 99 percent by weight, based on the total weight of the concentrate composition, acetone;
(b) 0.01 to 5 percent by weight, based on the total weight of the concentrate composition, of at least one pyrrolidone-derived surfactant; and
(c) 0.5 to 20 percent by weight, based on the total weight of the concentrate composition, dimethylethanolamine.

11. A concentrate composition for removing coatings from surfaces comprising:
(a) 50 to 99 percent by weight, based on the total weight of the concentrate composition, of a mixture of methyl acetate and acetone;
(b) 0.01 to 5 percent by weight, based on the total weight of the concentrate composition, of at least one pyrrolidone-derived surfactant; and
(c) 0.5 to 20 percent by weight, based on the total weight of the concentrate composition, dimethylethanolamine.

12. A concentrate composition for removing coatings from surfaces comprising:
(a) at least 20 percent by weight, based on the total weight of the concentrate composition, water;
(b) 0.01 to 5 percent by weight, based on the total weight of the concentrate composition, of at least one pyrrolidone-derived surfactant;
(c) 0.5 to 20 percent by weight, based on the total weight of the concentrate composition, dimethylethanolamine; and
(d) 0.01 to 5.0 percent by weight, based on the total weight of the concentrate composition, of at least one hydrotropic surfactant different from the other components in the composition.

13. A concentrate composition for removing coatings from surfaces comprising:
(a) at least 20 percent by weight, based on the total weight of the concentrate composition, water;
(b) 0.01 to 5 percent by weight, based on the total weight of the concentrate composition, of at least one surfactant selected from alkoxylated acetylenic compounds;
(c) 0.5 to 20 percent by weight, based on the total weight of the concentrate composition, dimethylethanolamine; and
(d) up to 5.0 percent by weight, based on the total weight of the concentrate composition, of at least one hydrotropic surfactant different from the other components in the composition.

14. A process for removing coatings from surfaces comprising:
(a) diluting a concentrate composition with water to form a cleaning solution; and
(b) contacting the surfaces with the cleaning solution until coating residues are substantially removed from the surfaces; wherein the concentrate composition comprises:
(i) 0 to 99.5 percent by weight, based on the total weight of the concentrate composition, of a carrier selected from at least one of acetone, methyl acetate and water;
(ii) 0.01 to 35 percent by weight, based on the total weight of the concentrate composition, of at least one surfactant selected from one or more of pyrrolidone-derived surfactants having substituents containing 6 to 14 carbon atoms and alkoxylated acetylenic compounds; and
(iii) 0.5 to 90 percent by weight, based on the total weight of the concentrate composition, of at least one pH adjusting component having the structure: 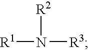
wherein R¹, R², and R³ are independently selected from the group consisting of hydrogen, alkanyl groups having 1 to 8 carbon atoms, hydroxyalkanyl groups having 1 to 8 carbon atoms, and aminoalkanyl groups having 1 to 8 carbon atoms; wherein the volatile organic compound (VOC) content of the composition is less than 2.0 lb./gal; and wherein when the concentrate composition contains at least 20% by weight water, based on the total weight of the concentrate composition, the concentrate composition may further comprise up to 5.0 percent by weight, based on the total weight of the concentrate composition, of at least one hydrotropic surfactant different from the other components in the concentrate composition.

15. The process of claim 14, wherein after step (a), the concentrate composition is present in the cleaning solution in an amount of 1 to 30 percent by weight, based on the total weight of the cleaning solution.

16. The process of claim 14, wherein the surfaces are contacted with the cleaning solution by spray application.

17. The process of claim 16, wherein the surfaces are contacted with the cleaning solution for a time ranging from 1 to 60 seconds.

18. The process of claim 14, wherein the surfaces are contacted with the cleaning solution by immersion.

19. The process of claim 18, wherein the surfaces are contacted with the cleaning solution for a time ranging from 0.1 to 24 hours.

20. The process of claim 14, wherein after step (a), the cleaning solution is heated to a temperature of 33 to 54° C.

21. The process of claim 14, wherein the surfaces to be cleaned comprise paint application equipment.

22. The process of claim 21, wherein during step (b), the cleaning solution is sprayed onto the paint application equipment.

23. The process of claim 21, wherein during step (b), the cleaning solution is circulated through the paint application equipment.

24. The process of claim 14, wherein component (i) includes at least 20% by weight water based on the total weight of the concentrate composition and further comprises a hydrotropic surfactant selected from the group consisting of aromatic and aliphatic sulfonates.

25. The process of claim 14, wherein the weight ratio of component (ii) to component (iii) ranges from 1:2 to 1:10.

26. The process of claim 14, wherein component (iii) is selected from one or more of ammonia, dimethylethanolamine, diethanolamine, triethanolamine, isopropanolamine, and aminomethylpropanol.

27. The process of claim 14, wherein component (i) is present in the concentrate composition in an amount ranging from 50 to 99 percent by weight, based on the total weight of the concentrate composition.

28. The process of claim 27, wherein component (i) is acetone.

29. The process of claim 14, wherein component (ii) is present in the concentrate composition in an amount ranging from 0.01 to 5 percent by weight, based on the total weight of the concentrate composition.

30. The process of claim 14, wherein component (iii) is present in the concentrate composition in an amount ranging from 0.5 to 20 percent by weight, based on the total weight of the concentrate composition.
